(19) United States
(12) Patent Application Publication
(10) Pub. No.: US 2025/0374933 A1
(43) Pub. Date: Dec. 11, 2025

(54) PALM-BASED SHORTENING SUBSTITUTE

(71) Applicant: Queen Margaret University, Musselburgh (GB)

(72) Inventors: Catriona LIDDLE, Musselburgh (GB); Julien LONCHAMP, Musselburgh (GB)

(73) Assignee: Queen Margaret University, Musselburgh (GB)

(21) Appl. No.: 18/874,500

(22) PCT Filed: Jul. 6, 2023
(86) PCT No.: PCT/GB2023/051783

§ 371 Date: Dec. 12, 2024

(30) Foreign Application Priority Data
Jul. 8, 2022 (GB) 2210046.5

(51) Int. Cl. A23D 9/007; A23D 7/005

(52) U.S. Cl. CPC A23D 9/007; A23D 7/0053

(57) ABSTRACT

A composition comprises linseed meal; a beta-glucan source; an oil; an acidifier; and water. The composition is particularly suitable as a substitute for palm-based shortening in food products.

### FIELD OF THE INVENTION

The present invention relates to a composition suitable for use as a replacement for palm fat derivatives, especially palm-based shortening. In particular, but not exclusively, the invention relates to a composition comprising linseed meal and beta-glucan.

### BACKGROUND

Due to its unique lipid composition allowing it to be solid at room temperature and its low production costs, palm-based shortening has become the main functional fat ingredient across the food industry, including the bakery sector in which it is used for its texturising, shortening, foam stabilisation and mouthfeel properties. However, due to the devastating environmental impact of palm over-cultivation, the industry is looking for sustainable alternatives. Alongside efforts to develop more sustainable cultivation practises, current palm fat replacement strategies have led to a number of commercial products. However, their impact and expansion are limited due to health-related concerns including high saturated fat content. There is currently no sustainable palm-based shortening alternative that offers comparable functionality and health/nutritional properties.

WO2015097417 (Lecointe) discloses a lipid composition that can be used in food products, which contains neither hydrogenated or partially hydrogenated fat nor palm oil. The lipid composition is an oil-in-water emulsion including starch, egg yolk, and oil which may be chosen from the group consisting of rapeseed, sunflower, peanut, avocado, safflower, olive, grapeseed, sesame, soybean, corn germ, walnut, pumpkin seed, poppy seed, flaxseed oil, and their mixtures.

CN108813140 (Zhao Qirui) discloses a nutrient-rich crayfish feed.

It is an object of the invention to address and/or mitigate one or more problems associated with the prior art.

### SUMMARY

The present disclosure is based upon the identification of a superior substitute for palm-based shortening, particular for use in food products. The substitute composition is sustainable and offers nutritional advantages in comparison with palm-based shortening and current palm-based shortening substitutes. The present palm-based shortening substitute is based on a novel combination of sustainable ingredients, particularly linseed meal and beta-glucan, which when co-processed is able to mimic palm fat functionality in food applications.

Unexpectedly, the present composition exhibits significantly enhanced oil-in-water emulsifying properties and oleogelling properties (capacity to form a gel-like structure trapping liquid rapeseed oil), which produces palm fat-like properties in food formulations.

According to a first aspect there is provided a composition comprising:
(i) linseed meal;
(ii) a beta-glucan source;
(iii) an oil;
(iv) an acidifier; and
(v) water.

The term “linseed meal” refers to a solid by-product of oil extraction from linseeds. A number of variants of this process exist, including cold pressing, hot pressing, and solvent extraction. The term “linseed meal” will be herein understood to be synonymous to other terms such as linseed oil meal, linseed oil cake, linseed cake, flaxseed meal, flax meal, or defatted linseed meal.

The linseed meal may have a residual oil content of about 5-15 wt %, typically, about 8-12 wt %.

The linseed meal may be prepared by pressing, e.g. cold pressing.

Typically, the amount of linseed meal in the composition may be in the range of about 0.1 to about 6 wt %, e.g. about 0.5 to about 5 wt %, e.g. about 1 to about 4 wt %, e.g. about 2 to about 3 wt %, based on the total weight of the composition.

The beta-glucan source may comprise, may consist of or may be beta-glucan or beta-glucan extract.

The beta-glucan source may comprise, may consist of or may be provided as a solid, e.g. a solid particle such as a powder. The beta-glucan source may comprise, may consist of or may be a beta-glucan powder.

Typically, the amount of beta glucan source in the composition may be in the range of about 0.1 to about 2 wt %, e.g. about 0.1 to about 1 wt %, e.g. about 0.2 to about 0.5 wt %, based on the total weight of the composition.

Typically, beta-glucan source may have a beta-glucan content of about 20-40 wt %, e.g. about 25-35 wt %. In an embodiment, the beta-glucan source may have a beta-glucan content of about 27-32 wt %, typically about 29 wt %. In another embodiment, the beta-glucan source may have beta-glucan content of about about 32-36 wt %, typically about 34 wt %. It will be appreciated that beta-glucan is not typically available in pure form, and as a result the beta-glucan source may have a beta-glucan content typical of readily-available beta-glucan products.

The beta-glucan source may have a beta-glucan content of about 29 wt %. In such instance, the amount of beta glucan source in the composition may be in the range of about 0.1 to about 2 wt %, e.g. about 0.1 to about 1 wt %, e.g. about 0.2 to about 0.5 wt %, based on the total weight of the composition.

Typically, the amount of beta glucan in the composition may be in the range of about 0.03 to about 0.58 wt %, e.g. about 0.03 to about 0.29 wt %, e.g. about 0.06 to about 0.15 wt %, based on the total weight of the composition.

The oil may be provided as a liquid oil.

The oil may comprise, may consist of or may be a vegetable oil. The oil may be selected from the list consisting of rapeseed oil, sunflower oil, olive oil, soybean oil, grapeseed oil, corn oil, sesame oil, peanut oil, or cottonseed oil. Typically, the oil may be selected from rapeseed oil and/or sunflower oil. These oils, and particularly rapeseed oil, were found to provide superior emulsifying properties in the present composition and/or more desirable flavour and/or colour properties. In addition, rapeseed oil and/or sunflower oil can be considered sustainable and/or to have a lesser environmental impact.

Typically, the amount of oil in the composition may be in the range of about 50 to about 90 wt %, e.g. about 60 to about 90 wt %, e.g. about 70 to about 80 wt %, based on the total weight of the composition.

The acidifier may comprise, may consist of or may be an organic acidifier, for example one or more acidifier selected from cider vinegar, white wine vinegar, red wine vinegar, lemon juice, citric acid, malic acid or combinations thereof.

The provision of an acidifier may allow control of the pH of the composition and/or may allow control of the stability of the resulting emulsion. Typically, the pH of the composition may be in the range of about 3 to 5.5, e.g. about 4 to 5, e.g. about 4.2 to 4.9.

The provision of an acidifier may allow extend the shelf life of the composition by lowering its pH.

The acidifier may be an aqueous acidifier, e.g. an aqueous solution of an organic acid. The acidifier, e.g. aqueous acid solution, may have an acidity in the range of about 4-10%, typically about 5-6%.

Typically, for an acidifier having about 5% or 6% acidity, the amount of acidifier in the composition may be in the range of about 0.1 to about 7 wt %, e.g. about 0.5 to about 5 wt %, e.g. about 1 to about 2 wt %, based on the total weight of the composition.

Typically, the amount of water in the composition may be in the range of about 10 to about 50 wt %, e.g. about 10 to about 30 wt %, e.g. about 15 to about 25 wt %, e.g. about 15 to about 17 wt %, based on the total weight of the composition.

The composition may comprise or may be provided as an oil-in-water emulsion.

The inventors have found that the provision of the above components allows the preparation of an oil-in-water emulsion which exhibit stability for at least 1 hour, e.g. at least 12 hours, e.g. at least 24 hours, e.g. at least 7 days, e.g. at least 4 weeks.

The composition may further comprise one or more additives, e.g. a thickener.

In an embodiment, the composition may comprise:
(i) about 0.1 to about 6 wt % linseed meal;
(ii) about 0.1 to about 2 wt % of a beta-glucan source;
(iii) about 50 to about 90 wt % of a vegetable oil;
(iv) about 0.1 to about 7 wt % of an organic acidifier; and
(v) about 10 to about 50 wt % water.

In an embodiment, the composition may comprise or may consist of:
(i) about 0.1 to about 6 wt % linseed meal;
(ii) about 0.03 to about 0.58 wt % of beta-glucan;
(iii) about 50 to about 90 wt % of a vegetable oil;
(iv) about 0.1 to about 7 wt % of an organic acidifier; and
(v) about 10 to about 50 wt % water.

In an embodiment, the composition may comprise:
(i) about 0.1 to about 6 wt % linseed meal;
(ii) about 0.1 to about 2 wt % of a 29 wt % beta-glucan source;
(iii) about 50 to about 90 wt % of rapeseed oil;
(iv) about 0.1 to about 7 wt % of an organic acidifier; and
(v) about 10 to about 50 wt % water.

The total amounts of components (i)-(v) may add to 100%.

In an embodiment, the composition may consist of:
(i) about 0.1 to about 6 wt % linseed meal;
(ii) about 0.1 to about 2 wt % of a 29 wt % beta-glucan source;
(iii) about 50 to about 90 wt % of rapeseed oil;
(iv) about 0.1 to about 7 wt % of an organic acidifier; and
(v) about 10 to about 50 wt % water,
wherein the total amounts of components (i)-(v) add to 100%.

In an embodiment, the composition may comprise or may consist of:
(i) about 2 to about 3 wt % linseed meal;
(ii) about 0.2 to about 0.5 wt % of a 29 wt % beta-glucan source;
(iii) about 70 to about 80 wt % of rapeseed oil;
(iv) about 1 to about 2 wt % of an organic acidifier such as a 5% acidity aqueous acid solution; and
(v) about 15 to about 25 wt % water,
wherein the total amounts of components (i)-(v) add to 100%.

In an embodiment, the composition may comprise or may consist of:
(i) about 2 to about 3 wt % linseed meal;
(ii) about 0.06 to about 0.15 wt % of beta-glucan;
(iii) about 70 to about 80 wt % of rapeseed oil;
(iv) about 1 to about 2 wt % of an organic acidifier such as a 5% acidity aqueous acid solution; and
(v) about 15 to about 25 wt % water,
wherein the total amounts of components (i)-(v) add to 100%.

According to a second aspect, there is provided a method for preparing a composition, the method comprising:
(a) combining linseed meal and a beta-glucan source;
(b) adding an oil; and
(c) adding water and an acidifier.

Step (a) may comprise mixing the linseed meal and the beta-glucan source. Mixing may be carried our manually, e.g. using a whisk, or may be automated, e.g. using a mixer.

Step (b) may comprise mixing the oil with the linseed meal and the beta-glucan source, optionally until a uniform and/or homogeneous mixture is obtained. Mixing may be carried our manually, e.g. using a whisk, or may be automated, e.g. using a mixer.

Step (c) may comprise adding water and the acidifier separately, or together as an aqueous mixture.

Step (c) may comprise mixing the components. Mixing may be carried our manually, e.g. using a whisk, or may be automated, e.g. using a mixer.

Step (c) may comprise mixing the components until a uniform mixture, e.g. emulsion, is obtained.

The method may comprise performing steps (a)-(c) sequentially.

The method, e.g. mixing step(s), may comprise using a mayonnaise pilot line.

The method may be performed at ambient temperature.

Alternatively, the method may further comprise heating the mixture at about 20° C. to about 70° C. for about 1 to 10 minutes.

The method may further comprise resting the composition for up to 20 minutes.

The method may further comprise homogenising the composition, for example at about 1,000 to 6,000 rpm for about 1 to 10 minutes.

The composition may comprise or may be provided as an oil-in-water emulsion.

The method may comprise preparing an oil-in-water emulsion.

According to a third aspect, there is provided the use of the composition according the first aspect, as a palm-based shortening substitute.

Advantageously, the composition may be used in or provided in an edible item.

The edible item may be selected form the list consisting of oatcake, biscuit, cookie, bread, cake, or mayonnaise.

According to a fourth aspect, there is provided an edible item, wherein the edible item comprises a composition comprising:
(i) linseed meal;
(ii) a beta-glucan source;
(iii) an oil;
(iv) an acidifier; and
(v) water.

The edible item may comprise the composition in an amount of about 1-30 wt %, e.g. about 2-20 wt %, based on the total weight of the edible item. It will be appreciated that the amount of the composition present the edible item will depend on the type of product being prepared, as certain types of foods, e.g. bread, typically require less fat content than other types, e.g. biscuits.

The amount of the composition in the edible item may be substantially similar to the amount of palm-based shortening that would typically be present in a conventional edible item.

Typically, the amount (by weight) of the composition in the edible item may be about 1-50% greater, e.g. about 10-50% greater, e.g. about 20-40% greater, than the amount of palm-based shortening that would typically be present in a conventional edible item.

The edible item may be selected form the list consisting of oatcake, biscuit, cookie, bread, cake, or mayonnaise. It will be appreciated that the edible item may include any other food product which would typically include a conventional fat ingredient such as palm-based shortening.

The features described in relation to the composition of the first aspect may equally apply to the method of the second aspect and/or to the use of the third aspect or item of the fourth aspect, and vice versa, and are not repeated here merely for brevity.

### BRIEF DESCRIPTION OF DRAWINGS

Embodiments of the present disclosure will now be given by way of example only, and with reference to the accompanying drawings, which are:

FIG. 1 a graph showing oil droplet size distribution of a composition according to an embodiment, at different pH and different storage points;

FIG. 2 Shear viscosity profile of a composition according to an embodiment.

### DETAILED DESCRIPTION

In the present disclosure, reference is made to a number of terms, which have the meanings provided below, unless a context indicates to the contrary.

The term “comprising” or variants thereof is to be understood herein to imply the inclusion of a stated element, integer or step, or group of elements, integers or steps, but not the exclusion of any other element, integer or step, or group of elements, integers or steps.

The term “consisting” or variants thereof is to be understood to imply the inclusion of a stated element, integer or step, or group of elements, integers or steps, and the exclusion of any other element, integer or step or group of elements, integers or steps.

The term “about” herein, when qualifying a number or value, is used to refer to values that lie within ±5% of the value specified. For example, if the temperature is specified to be about 5 to about 13° C., temperatures of 4.75 to 13.65° C. are included.

Reference to physical states of matter (such as liquid or solid) refer to the matter's state at 25° C. and atmospheric pressure unless the context dictates otherwise.

By “aqueous mixture” is meant a mixture comprising water and at least one other component. The aqueous mixture of the invention need not be a solution, i.e. the components of the mixture need not be dissolved fully in solution. For the avoidance of doubt, aqueous suspensions and slurries, i.e. mixtures in which at least some components are present as solids within water, are included.

As explained above, the present disclosure is based upon the identification of a superior substitute for palm-based shortening, particular for use in food products. The substitute composition is sustainable and offers nutritional advantages in comparison with palm-based shortening and current palm-based shortening substitutes. The present palm-based shortening substitute is based on a novel combination of sustainable ingredients, particularly linseed meal and beta-glucan, which when co-processed is able to mimic palm fat functionality in food applications.

Unexpectedly, the present composition exhibits significantly enhanced oil-in-water emulsifying properties and oleogelling properties (capacity to form a gel-like structure trapping liquid rapeseed oil), which produces palm fat-like properties in food formulations.

The present composition comprises:
(i) linseed meal;
(ii) a beta-glucan source;
(iii) an oil;
(iv) an acidifier; and
(v) water.

### Formulations

A generic formulation of an embodiment of the present composition is shown in Table 1.

TABLE 1

| Ingredient | wt % |
|---|---|
| Dry mix | |
| Linseed meal | 0.5-6 |
| Beta-glucan source | 0.11-2 |
| Water phase | |
| Water | 15-45 |
| Acidifier (cider vinegar, | 0.1-7 |
| lemon juice, citric acid, malic | |
| acid and combinations thereof) | |
| Oil phase | |
| Oil (rapeseed, sunflower, vegetable) | 55-85 |
| pH | 3.0-5.5 |

An optimised formulation of an embodiment of the present composition (identified as “PALM-ALT”) is shown in Table 2.

TABLE 2

| Ingredient | Weight (g) | wt % |
|---|---|---|
| Dry mix | | |
| Defatted linseed meal | 22.60 | 2.26 |
| Beta-glucan source | 3.80 | 0.38 |
| Water phase | | |
| Water | 215.30 | 21.53 |
| Cider vinegar (5% acidity) | 11.30 | 1.13 |
| Oil phase | | |
| Rapeseed oil | 747.00 | 74.70 |
| Total | 1000.00 | 100.00 |
| pH | 4.75 | |

### Materials

### Linseed Meal:

The linseed meal ingredient used to prepare the PALM-ALT composition of Table 2 was FOODSOLUTE® LINSOL FLOUR ORGANIC from Marbacher Ölmühle GmbH. The composition of the defatted linseed meal ingredient is shown in Table 3 below.

TABLE 3

| Ingredient (per 100 g) | Average | Range |
|---|---|---|
| Energy (kJ) | 1,252 | n/a |
| Enery (kcalories) | 300 | n/a |
| Fat (g) | 10 | 8-12 |
| Saturated fat (g) | 1.5 | n/a |
| Carbohydrate (g) | 2.2 | n/a |
| Sugar (g) | 2.0 | n/a |
| Protein (g) | 34 | 27-41 |
| Salt (g) | 0.14 | n/a |
| Fibre (g) | n/a | 34-50 |

### Beta-Glucan Source:

The beta-glucan source used to prepare the PALM-ALT composition of Table 2 was PromOat® Beta Glucan Gluten-Free from Lantmännen Oats AB. The composition of the defatted linseed meal ingredient is shown in Table 4 below.

TABLE 4

| Ingredient (per 100 g) | Weight (g/100 g) |
|---|---|
| Energy (kJ) | 1,410 |
| Enery (kcalories) | 337 |
| Fat (g/100 g) | 7.0 |
| Saturated fat (g/100 g) | 1.3 |
| Monounsaturated fat (g/100 g) | 2.4 |
| Polyunsaturated fat (g/100 g) | 2.8 |
| Carbohydrate (g/100 g) | 43.5 |
| Sugar (g/100 g) | 2.0 |
| Protein (g/100 g) | 5.0 |
| Salt (g/100 g) | 0.2 |
| Dietary fibre (g/100 g) | 36.0 |
| Beta-glucan (g/100 g) | 29.0 |

### Oil:

The oil used to prepare the PALM-ALT composition of Table 2 was Albex Crystal rapeseed oil.

### Acidifier:

The acidifier used to prepare the PALM-ALT composition of Table 2 was Aspall cider vinegar (5% acidity).

### Methods

### Lab-Scale Processing Method

For lab-scale preparation of a composition according to Table 1 above, the processing conditions were as follows:
a. The dry mix components were combined using a whisk.
b. The oil was added and the mixture was gently whisked until uniform.
c. The water phase was then added and the mixture was gently whisked until uniform.
d. The mixture was unheated or heated at 20 to 70° C. during 1 to 10 minutes
e. The mixture was let to rest for 0 to 20 minutes
f. The mixture was homogenised in a Silverson L5M mixer fitted with either a standard emulsor screen, a square hole high-shear screen or a general purpose disintegrating head at 1,000 to 6,000 rpm for 1 to 10 minutes.

The method was also optimised for the composition according to Table 2 above. This optimised method was based on the following specific conditions:
A standard emulsor screen was used.
The mixture was not heated and not rested;
Mixing regime: 2,000 rpm for 60 seconds then 5,800 rpm for 60 seconds.

### Pilot-Scale Processing Method

Using the formulation of Table 2, the following method was used for pilot scale preparation.
a. A Silverson MP45 mayonnaise pilot line was used.
b. The rapeseed oil was added to the oil tank and the water phase was added to the mixer tank.
c. The two phases were mixed using the following regime:
   500 rpm for 1 minute
   then 1,000 rpm for 1 minute
   then held at 1,500 rpm
d. The dry mix was added and the mixing regime shown in Table 5 was applied.
e. Once all the oil has been incorporated (around 12 minutes), the mixer speed was reduced to 2,000 rpm and the homogenised mixture was dispensed into buckets.

TABLE 5
Mixing regime of the pilot-scale preparation process

| Time (minutes:seconds) | Mixer Speed (rpm) |
|---|---|
| 0 | 1,500 |
| 1:10 | 1,750 |
| 2:10 | 2,000 |
| 3:45 | 2,500 |
| 5.55 | 3,000 |

### Functional Screening

### Functional Screening of the Ingredients Tested During Initial Qualitative Tests is Summarised in Table 6 Below.

TABLE 6

| | Effect of component in PALM-ALT | |
|---|---|---|
| Ingredient | ingredient and formulations | Outcome |
| Oil | | |
| Rapeseed oil | Preferred flavour | Successful |
| Extended life rapeseed oil | Preferred flavour | Successful |
| Cold-pressed rapeseed oil | Flavour and colour too intense, cost too high | |
| Sunflower oil | n/a | Successful |
| Olive oil | Flavour too intense, cost too high | |

Functional components added to beta-glucan extract

| | | |
|---|---|---|
| Pea protein | Unstable emulsion, flavour too intense | |
| Chia seed protein | Unstable emulsion, colour too dark | |
| Whey protein concentrate | Low emulsion stability | |
| Whey protein isolate | Low emulsion stability | |
| Soy protein isolate | Solubility issues, unstable emulsion | |
| Defatted pumpkin seed meal | Unstable emulsion, green off-colour | |
| Defatted sunflower seed meal | Green off-colour | |
| Defatted linseed meal | High emulsion stability | Successful |

Thickeners added to the combination of
defatted linseed meal and beta-glucan extract

| | |
|---|---|
| Maize starch | Functionality in PALM-ALT ingredient, limited |
| | palm fat-like functionality in applications |
| Gluten-free wheat starch | Limited palm fat-like functionality in |
| | applications |
| Inulin (liquid) | Functionality in PALM-ALT ingredient, limited |
| | palm fat-like functionality in applications |
| Inulin (powder) | Functionality in PALM-ALT ingredient, limited |
| | palm fat-like functionality in applications |
| Fibresmart (liquid) | Functionality in PALM-ALT ingredient, limited |
| | palm fat-like functionality in applications |
| Fibresmart (powder) | Functionality in PALM-ALT ingredient, limited |
| | palm fat-like functionality in applications |

Acidifier added to the combination of
defatted linseed meal and beta-glucan extract

| | | |
|---|---|---|
| Lemon juice | Functionality in PALM-ALT ingredient, limited | |
| | factory-scale potential | |
| White wine vinegar | Functionality in PALM-ALT ingredient | Successful |
| (5% acidity) | | |
| Cider vinegar | Functionality in PALM-ALT ingredient, | Successful |
| (6% acidity) | preferred flavour | |
| Citric acid | Functionality in PALM-ALT ingredient | Successful |
| Malic acid | Functionality in PALM-ALT ingredient | Successful |
| Combinations of cider | Functionality in PALM-ALT ingredient, good | Successful |
| vinegar and citric acid | flavour | |

### Characterisation

### Characterisation of the Lab-Scale PALM-ALT Ingredient

### Nutritional Profile

Table 7 shows the nutritional profile of the composition “PALM-ALT” according to the formulation of Table 2.

TABLE 7

| | Palm- | | | | |
|---|---|---|---|---|---|
| | based | Rapeseed | PALM- | % difference | % difference |
| Nutrient | shortening | oil | ALT | in PA (PBS | in PA (RO |
| (per 100 g) | (PBS) | (RO) | (PA) | comparison) | comparison) |
| Energy (kJ) | 3,765 | 3,696 | 2,843 | −24.5% | −23.1% |
| Energy (kcalories) | 900 | 899 | 679 | −24.6% | −24.5% |
| Fat (g) | 100.0 | 100.00 | 74.9 | −25.1% | −25.1% |
| Saturated fat (g) | 42.2 | 6.6 | 5.00 | −88.3% | −24.9% |
| Monounsaturated | 44.1 | 57.0 | 42.6 | −3.5% | −25.3% |
| fat (g) | | | | | |
| Polyunsaturated | 13.6 | 32.0 | 23.9 | +75.8% | −25.3% |
| fat (g) | | | | | |
| Carbohydrate (g) | 0.0 | 0.0 | 0.2 | | |
| Sugar (g) | 0.0 | 0.0 | 0.1 | | |
| Fibre (g) | 0.0 | 0.0 | 0.9 | | |
| Protein (g) | 0.0 | 0.0 | 0.8 | | |
| Sodium as salt (g) | 0.0 | 0.0 | 0.0 | | |

Thus, as shown in Table 7, the “PALM-ALT” formulation provides a dramatic reduction in the level of saturated fat in comparison with palm-based shortening. The PALM-ALT formulation also shows a lower total fat level (25.1% decrease) and a higher polyunsaturated fat level (75.8% increase) than palm-based shortening.

### Oil Droplet Size Distribution and Stability

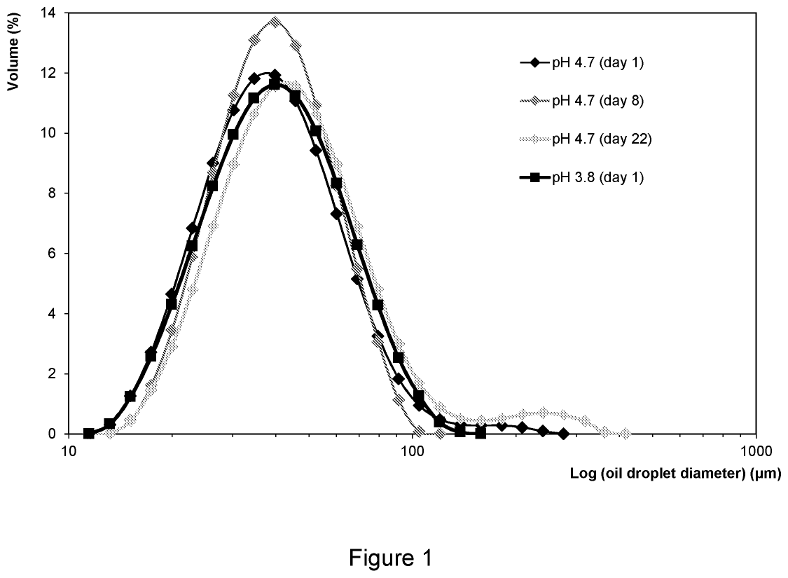

FIG. 1 is a graph showing oil droplet size distribution of a composition according to the formulation of Table 2, made by the lab-scale method.

The mean oil droplet size of the composition at different pH and different storage points (D[3, 2] Surface weighted mean) is also shown in Table 8.

TABLE 8

| Parameter | D[3, 2] (μm) |
|---|---|
| pH 4.7 (day 1) | 32.93 ± 0.53 |
| pH 4.7 (day 8) | 34.08 ± 0.05 |
| pH 4.7 (day 22) | 37.85 ± 0.05 |
| pH 3.8 (day 1) | 33.81 ± 0.70 |

FIG. 1 and Table 8 show that the composition had a stable oil droplet size distribution over a 4-week storage period. This demonstrated the stability of the emulsion of the present composition, and thus its potential suitability as a substitute for palm-based shortening.

### Shear Viscosity Profile

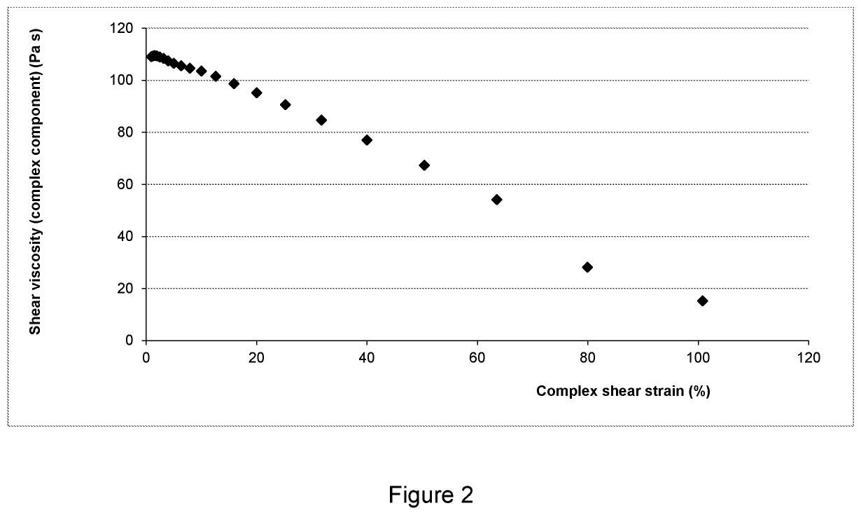

FIG. 2 is a graph showing the shear viscosity profile of a composition according to the formulation of Table 2, over complex shear strain increase.

The shear viscosity (complex component) of the PALM-ALT formulation was measured over a complex shear strain ranging from 0 to 100% using a Kinexus Pro+ rotational rheometer (Netzsch, Germany). The initial viscosity was measured at 109 Pa.s.

Characterisation of Palm-Free Model Oatcakes Prepared with the PALM-ALT Formulation

### (a) Composition of the Oatcake Products

Table 9 shows the composition of oatcakes prepared with the PALM-ALT formulation.

TABLE 9

| | Palm-based | | | | | |
|---|---|---|---|---|---|---|
| | shortening | | Rapeseed oil | | PALM-ALT | |
| Ingredient | Weight (g) | % | Weight (g) | % | Weight (g) | % |
| Rolled oats | 450 | 53.6 | 450 | 53.3 | 450 | 53.3 |
| Wholewheat flour | 120 | 14.3 | 120 | 14.2 | 120 | 14.2 |
| Bicarbonate of soda | 5 | 0.6 | 5 | 0.6 | 5 | 0.6 |
| Salt | 5 | 0.6 | 5 | 0.6 | 5 | 0.6 |
| Caster sugar | 4 | 0.5 | 4 | 0.5 | 4 | 0.5 |
| Water | 165 | 19.7 | 140 | 16.6 | 140 | 16.6 |
| Palm fat shortening | 90 | 10.7 | 0 | 0.0 | 0 | 0.0 |
| Rapeseed oil | 0 | 0.0 | 120 | 14.2 | 0 | 0.0 |
| PALM-ALT | 0 | 0.0 | 0 | 0.00 | 120 | 14.2 |
| Total | 121.0 | 100 | 111.6 | 100 | 120.5 | 100 |

The rapeseed oil and PALM-ALT components were incorporated in their respective formulations at a 33% higher concentration than palm-based shortening in its formulation

### (b) Nutritional Profile of the Oatcake Products

Table 10 shows the nutritional profile of oatcakes prepared with the PALM-ALT formulation (at pre-bake stage)

TABLE 10

| | Palm- | | | % dif- | % dif- |
|---|---|---|---|---|---|
| | based | Rape- | | ference | ference |
| Nutrient | short- | seed | PALM- | in PA | in PA |
| (per 100 g) | ening | oil | ALT | (PBS com- | (RO com- |
| (pre-bake stage) | (PBS) | (RO) | (PA) | parison) | parison) |
| Energy (kJ) | 1,460 | 1,460 | 1,411 | −3.4% | −3.4% |
| Energy | 348 | 348 | 337 | −3.2% | −3.2% |
| (kcalories) | | | | | |
| Fat (g) | 15.3 | 15.3 | 14.8 | −3.6% | −3.6% |
| Saturated fat (g) | 5.3 | 1.4 | 1.3 | −75.3% | −3.7% |
| Monounsaturated | 8.5 | 9.9 | 9.5 | +12.3% | −3.9% |
| fat (g) | | | | | |
| Polyunsaturated | 1.5 | 3.5 | 3.4 | +126.6% | −3.9% |
| fat (g) | | | | | |
| Carbohydrate (g) | 43.5 | 43.5 | 42.0 | | |
| Sugar (g) | 1.3 | 1.3 | 1.3 | | |
| Fibre (g) | 6.1 | 6.1 | 6.0 | | |
| Protein (g) | 7.5 | 7.5 | 7.3 | | |
| Sodium as salt (g) | 1.0 | 1.0 | 1.0 | | |

Thus, as shown in Table 10, the “PALM-ALT” formulation provides dramatically reduced saturated fat content in comparison with palm-based shortening. The PALM-ALT oatcake formulation also shows a higher polyunsaturated fat level (126.6% increase) than the palm-based shortening formulation, which is nutritionally beneficial.

### (c) Sensory Analysis of the Oatcake Products

The sensory analysis highlighted that the colour intensity, hardness and crunchiness of the PALM-ALT product were similar to those of the palm-based shortening control, while the values obtained with the rapeseed oil control were significantly different to the palm-based shortening and PALM-ALT products (p<0.05) (see Table 11). The overall acceptability of the PALM-ALT product was statistically higher than the other two products (p<0.05). The other parameters were similar between the three products.

TABLE 11
Sensory analysis profile of oatcakes prepared
with the PALM-ALT composition

| | | | |
|---|---|---|---|
| | Palm-based | Rapeseed | PALM- |
| Properties | shortening | oil | ALT |

1. Quantitative Descriptive Analysis (QDA)
Appearance/colour

| | | | |
|---|---|---|---|
| Colour intensity | 5.2 ± 0.5 ^{b} | 5.6 ± 0.3 ^{a} | 5.2 ± 0.5 ^{b} |
| Roughness-to-smoothness | 5.4 ± 1.1 | 5.6 ± 0.7 | 5.5 ± 1.1 |

Odour

| | | | |
|---|---|---|---|
| Overall odour intensity | 4.5 ± 0.7 | 4.9 ± 0.4 | 4.7 ± 0.9 |

Touch

| | | | |
|---|---|---|---|
| Oiliness | 4.8 ± 0.9 | 4.9 ± 0.3 | 5.1 ± 1.0 |

Flavour

| | | | |
|---|---|---|---|
| Overall flavour intensity | 4.8 ± 0.8 ^{b} | 5.4 ± 0.4 ^{a} | 5.5 ± 0.8 ^{a} |
| Saltiness | 4.7 ± 0.8 | 4.7 ± 0.4 | 4.7 ± 1.0 |

Texture

| | | | |
|---|---|---|---|
| Hardness | 4.8 ± 0.6 ^{a} | 4.4 ± 0.4 ^{b} | 5.1 ± 0.5 ^{a} |
| Crunchiness | 5.3 ± 0.9 ^{a} | 4.3 ± 0.4 ^{b} | 5.5 ± 0.7 ^{a} |
| Pastiness | 4.8 ± 0.7 | 5.4 ± 0.8 | 5.0 ± 1.0 |
| Moistness | 4.9 ± 0.9 | 5.0 ± 0.4 | 5.1 ± 0.7 |
| Fat mouthfeel | 4.6 ± 0.9 | 5.1 ± 0.4 | 4.9 ± 0.9 |

Overall

| | | | |
|---|---|---|---|
| Overall sensory quality | 5.0 ± 0.7 ^{ab} | 4.7 ± 0.5 ^{b} | 5.4 ± 0.7 ^{a} |

2. Consumer analysis (hedonic)

| | | | |
|---|---|---|---|
| Overall | 4.8 ± 1.1 ^{b} | 4.3 ± 1.0 ^{b} | 5.7 ± 1.0 ^{a} |
| acceptability (n = 38) | | | |

### (d) Instrumental Analysis of the Oatcake Products

TABLE 12
Instrumental analysis profile of oatcakes
prepared with the PALM-ALT composition

| | | | |
|---|---|---|---|
| | Palm-based | Rapeseed | |
| Properties | shortening | oil | PALM-ALT |

Physicochemical properties

| | | | |
|---|---|---|---|
| Water activity | 0.25 ± 0.03 | 0.26 ± 0.04 | 0.26 ± 0.06 |
| Moisture (%) | 4.81 ± 0.43 | 4.81 ± 0.35 | 4.87 ± 0.49 |

CIE-Lab colour

| | | | |
|---|---|---|---|
| Lightness (L*) | 38.76 ± 3.26 | 39.73 ± 1.96 | 42.67 ± 2.33 |
| Redness (a*) | 6.48 ± 1.17 | 6.72 ± 1.01 | 7.50 ± 0.83 |
| Yellowness (b*) | 9.93 ± 0.96 | 10.02 ± 0.65 | 10.98 ± 0.30 |
| Hue (h*) | 11.94 ± 1.43 | 12.17 ± 1.04 | 13.40 ± 0.70 |
| Chroma (C*) | 56.02 ± 1.85 | 54.93 ± 1.32 | 55.08 ± 2.07 |

Texturometry

| | | | |
|---|---|---|---|
| Hardness (N) | 30.52 ± 5.77 | 29.81 ± 3.66 | 34.75 ± 6.64 |

No significant differences in instrumental analysis parameters were reported between the three samples (Table 12).

### (e) Conclusion

These results highlighted that the PALM-ALT model oatcake closely matched the sensory profile of the palm fat oatcake control (whereas the rapeseed oil control did not) while offering nutritional benefits (reduced saturated fat and low saturated fat). The consumer panel results showed that the PALM-ALT oatcake formulation was more acceptable than the palm fat and rapeseed oil control.

Characterisation of Palm-Free Model Biscuits Prepared with the PALM-ALT Formulation

### (a) Composition of the Biscuit Products

Table 13 shows the composition of biscuits prepared with the PALM-ALT formulation.

TABLE 13

| | Palm-based | | | | | |
|---|---|---|---|---|---|---|
| | shortening | | Rapeseed oil | | PALM-ALT | |
| Ingredient | Weight (g) | % | Weight (g) | % | Weight (g) | % |
| Plain wheat flour | 800 | 48.5 | 800 | 48.5 | 800 | 48.5 |
| Caster sugar | 400 | 24.3 | 400 | 24.3 | 400 | 24.3 |
| Baking powder | 8 | 0.5 | 8 | 0.5 | 8 | 0.5 |
| Liquid egg | 110 | 6.7 | 110 | 6.7 | 110 | 6.7 |
| Vanilla extract | 10 | 0.6 | 10 | 0.6 | 10 | 0.6 |
| Palm fat shortening | 320 | 19.4 | 0 | 0.0 | 0 | 0.0 |
| Rapeseed oil | 0 | 0.0 | 320 | 19.4 | 0 | 0.0 |
| PALM-ALT | 0 | 0.0 | 0 | 0.00 | 320 | 19.4 |
| Total | 1648 | 100.0 | 1648 | 100.0 | 1648 | 100.0 |

The PALM-ALT component was incorporated in its formulation at the same concentration than palm fat shortening and rapeseed oil in their respective formulations.

### (b) Nutritional Profile of the Biscuit Products

Table 14 shows the nutritional profile of biscuits prepared with the PALM-ALT formulation (at pre-bake stage)

TABLE 14

| | Palm- | | | % dif- | % dif- |
|---|---|---|---|---|---|
| | based | Rape- | | ference | ference |
| Nutrient | short- | seed | PALM- | in PA | in PA |
| (per 100 g) | ening | oil | ALT | (PBS com- | (RO com- |
| (pre-bake stage) | (PBS) | (RO) | (PA) | parison) | parison) |
| Energy (kJ) | 1,865 | 1,865 | 1,686 | −9.6% | −9.6% |
| Energy | 445 | 445 | 403 | −9.4% | −9.4% |
| (kcalories) | | | | | |
| Fat (g) | 20.5 | 20.5 | 15.6 | −23.7% | −23.7% |
| Saturated fat (g) | 8.5 | 1.6 | 1.2 | −85.5% | −20.6% |
| Monounsaturated | 9.2 | 11.7 | 8.9 | −3.3% | −24.1% |
| fat (g) | | | | | |
| Polyunsaturated | 2.7 | 6.3 | 4.7 | +73.2% | −24.9% |
| fat (g) | | | | | |
| Carbohydrate (g) | 59.2 | 59.2 | 59.3 | | |
| Sugar (g) | 24.5 | 24.5 | 24.5 | | |
| Fibre (g) | 1.2 | 1.7 | 1.9 | | |
| Protein (g) | 5.6 | 5.6 | 5.7 | | |
| Sodium as salt (g) | 0.1 | 0.1 | 0.1 | | |

Thus, as shown in Table 14, the “PALM-ALT” formulation provides dramatically reduced saturated fat content in comparison with palm-based shortening product. The PALM-ALT biscuit formulation also shows a lower total fat level (23.7% decrease) and a higher polyunsaturated fat level (73.2% increase) than the palm-based shortening formulation.

### (c) Sensory Analysis of the Biscuit Products

The sensory analysis highlighted that the colour intensity, odour intensity, hardness, crunchiness and overall sensory quality of the PALM-ALT product were similar to those of the palm-based shortening control, while the values obtained with the rapeseed oil control for these attributes were significantly different to the palm-based shortening product (and in some cases to the PALM-ALT product) (p<0.05) (Table 15). The overall acceptability of the PALM-ALT product was similar to that of the palm-based shortening control, which value was statistically higher than the one of the rapeseed oil control (p<0.05). The other parameters were similar between the three products.

TABLE 15
Sensory analysis profile of biscuits prepared
with the PALM-ALT composition

| | | | |
|---|---|---|---|
| | Palm-based | Rapeseed | PALM- |
| Properties | shortening | oil | ALT |

1. Quantitative Descriptive Analysis (QDA)
Appearance/colour

| | | | |
|---|---|---|---|
| Colour intensity | 5.2 ± 0.5 ^{b} | 6.1 ± 1.4 ^{a} | 5.0 ± 0.4 ^{b} |

Odour

| | | | |
|---|---|---|---|
| Overall odour intensity | 5.0 ± 0.6 ^{b} | 5.4 ± 0.8 ^{a} | 5.2 ± 1.1 ^{ab} |

Touch

| | | | |
|---|---|---|---|
| Oiliness | 5.2 ± 0.5 | 5.5 ± 0.8 | 5.0 ± 1.1 |

Flavour

| | | | |
|---|---|---|---|
| Overall flavour intensity | 5.3 ± 0.8 | 5.4 ± 1.2 | 5.0 ± 0.8 |
| Creamy/fatty flavour | 5.1 ± 0.4 | 4.6 ± 0.7 | 5.0 ± 0.6 |
| Sweetness | 5.3 ± 0.5 | 4.9 ± 0.5 | 5.0 ± 0.4 |
| Saltiness | 4.4 ± 0.9 | 4.3 ± 0.8 | 4.2 ± 0.8 |
| Acidity | 5.3 ± 0.7 | 5.2 ± 1.0 | 4.9 ± 0.9 |

Texture

| | | | |
|---|---|---|---|
| Hardness | 5.1 ± 0.3 ^{b} | 6.3 ± 0.8 ^{a} | 5.1 ± 0.4 ^{b} |
| Crunchiness | 5.4 ± 0.8 ^{b} | 6.1 ± 1.0 ^{a} | 5.7 ± 0.7 ^{b} |
| Crumbliness | 5.7 ± 0.7 | 5.6 ± 1.0 | 5.8 ± 0.8 |
| Moistness | 5.3 ± 0.7 | 5.0 ± 0.9 | 5.3 ± 0.7 |
| Fat mouthfeel | 5.0 ± 0.7 | 4.9 ± 0.6 | 5.0 ± 0.8 |

Overall

| | | | |
|---|---|---|---|
| Overall sensory quality | 5.1 ± 0.6 ^{a} | 4.1 ± 1.1 ^{b} | 4.9 ± 1.4 ^{ab} |

2. Consumer analysis (hedonic)

| | | | |
|---|---|---|---|
| Overall | 5.0 ± 1.0 ^{a} | 3.7 ± 1.1 ^{b} | 4.7 ± 1.4 ^{ab} |
| acceptability (n = 38) | | | |

### (d) Instrumental Analysis of the Biscuit Products

TABLE 16
Instrumental analysis profile of biscuits
prepared with the PALM-ALT composition

| | | | |
|---|---|---|---|
| | Palm-based | Rapeseed | |
| Properties | shortening | oil | PALM-ALT |

Physicochemical properties

| | | | |
|---|---|---|---|
| Water | 0.19 ± 0.06 | 0.19 ± 0.03 | 0.24 ± 0.01 |
| activity | | | |
| Moisture (%) | 2.71 ± 0.57 | 2.76 ± 0.10 | 3.52 ± 0.05 |

CIE-Lab colour

| | | | |
|---|---|---|---|
| Light- | 37.47 ± 0.22 | 29.28 ± 0.88 | 40.09 ± 0.20 |
| ness (L*) | | | |
| Redness (a*) | 7.11 ± 0.01 | 7.45 ± 0.37 | 7.22 ± 0.17 |
| Yellow- | 11.28 ± 0.51 | 12.36 ± 0.05 | 12.18 ± 0.32 |
| ness (b*) | | | |
| Hue (h*) | 13.45 ± 0.42 | 14.48 ± 0.24 | 14.21 ± 0.37 |
| Chroma (C*) | 56.52 ± 1.06 | 58.69 ± 1.22 | 58.96 ± 0.11 |

Texturometry

| | | | |
|---|---|---|---|
| Hardness (N) | 46.20 ± 5.40 ^{b} | 60.55 ± 11.41 ^{a} | 41.57 ± 5.53 ^{b} |

Similarly to the sensory results, the instrumental analysis highlighted that the hardness of the PALM-ALT product was similar to that of the palm-based shortening control, while the hardness of the rapeseed oil control was significantly higher than the palm-based shortening and PALM-ALT products (p<0.05) (Table 16). The other parameters were similar between the three products.

### (e) Conclusion

The results highlighted that the PALM-ALT model biscuit closely matched the sensory profile of the palm-based shortening biscuit control (whereas the rapeseed oil control did not) while offering nutritional benefits (reduced saturated fat and low saturated fat claims).

Characterisation of Palm-Free Model Chocolate Cookies Prepared with the PALM-ALT Formulation

### (a) Composition of the Cookie Products

Table 17 shows the composition of cookies prepared with the PALM-ALT formulation.

TABLE 17

| | Palm-based | | Rapeseed | | | |
|---|---|---|---|---|---|---|
| | shortening | | oil | | PALM-ALT | |
| | Weight | | Weight | | Weight | |
| Ingredient | (g) | % | (g) | % | (g) | % |
| Palm fat shortening | 100 | 12.3 | 0 | 0.0 | 0 | 0 |
| Rapeseed oil | 0 | 0.0 | 100 | 12.3 | 0 | 0.0 |
| PALM-ALT | 0 | 0.0 | 0 | 0.0 | 100 | 12.3 |
| Soft brown sugar | 115 | 14.1 | 115 | 14.1 | 115 | 14.1 |
| Caster sugar | 115 | 14.1 | 115 | 14.1 | 115 | 14.1 |
| Whole egg | 46 | 5.6 | 46 | 5.6 | 46 | 5.6 |
| Vanilla extract | 4 | 0.5 | 4 | 0.5 | 4 | 0.5 |
| Plain flour | 225 | 27.6 | 225 | 27.6 | 225 | 27.6 |
| Baking powder | 5 | 0.6 | 5 | 0.6 | 5 | 0.6 |
| Salt | 5 | 0.6 | 5 | 0.6 | 5 | 0.6 |
| Chocolate chips | 100 | 12.3 | 100 | 12.3 | 100 | 12.3 |
| Sultanas | 100 | 12.3 | 100 | 12.3 | 100 | 12.3 |
| Total | 815 | 100.0 | 815 | 100.0 | 815 | 100.0 |

The PALM-ALT component was incorporated in its formulation at the same concentration than palm-based shortening and rapeseed oil in their respective formulations.

### (b) Nutritional Profile of the Cookie Products

Table 18 shows the nutritional profile of model cookies prepared with the PALM-ALT formulation (at pre-bake stage)

TABLE 18

| | Palm- | | | % dif- | % dif- |
|---|---|---|---|---|---|
| | based | Rape- | | ference | ference |
| Nutrient | short- | seed | PALM- | in PA | in PA |
| (per 100 g) | ening | oil | ALT | (PBS com- | (RO com- |
| (pre-bake stage) | (PBS) | (RO) | (PA) | parison) | parison) |
| Energy (kJ) | 1,767 | 1,767 | 1,654 | −6.4% | −6.4% |
| Energy | 422 | 422 | 395 | −6.4% | −6.4% |
| (kcalories) | | | | | |
| Fat (g) | 17.9 | 17.9 | 14.8 | −17.2% | −17.2% |
| Saturated fat (g) | 8.2 | 3.8 | 3.6 | −55.6% | −5.2% |
| Monounsaturated | 7.8 | 9.4 | 7.6 | −2.4% | −18.8% |
| fat (g) | | | | | |
| Polyunsaturated | 1.8 | 4.0 | 3.0 | +72.3% | −24.8% |
| fat (g) | | | | | |
| Carbohydrate (g) | 60.2 | 60.2 | 60.2 | | |
| Sugar (g) | 40.0 | 40.0 | 40.0 | | |
| Fibre (g) | 1.2 | 1.2 | 1.3 | | |
| Protein (g) | 4.8 | 4.8 | 4.9 | | |
| Sodium as salt (g) | 0.6 | 0.6 | 0.6 | | |

Thus, as shown in Table 18, the “PALM-ALT” formulation provides dramatically reduced saturated fat content in comparison with palm-based shortening product. The PALM-ALT cookie formulation also shows a lower total fat level (17.2% decrease) and a higher polyunsaturated fat level (72.3% increase) than the palm-based shortening formulation.

### (c) Sensory Analysis of the Cookie Products

The sensory analysis highlighted that the colour intensity, oiliness, hardness, crunchiness and fat mouthfeel of the PALM-ALT product were similar to those of the palm-based shortening control, while the values obtained with the rapeseed oil control for these attributes were significantly different to the palm-based shortening product (and in some cases to the PALM-ALT product) (p<0.05) (Table 19). The overall acceptability of the PALM-ALT product was similar to that of the palm-based shortening control, and both samples proved statistically more acceptable than the rapeseed oil control (p<0.05). The other parameters were similar between the three products.

TABLE 19
Sensory analysis profile of cookies prepared
with the PALM-ALT composition

| | | | |
|---|---|---|---|
| | Palm-based | Rapeseed | PALM- |
| Properties | shortening | oil | ALT |

1. Quantitative Descriptive Analysis (QDA)
Appearance/colour

| | | | |
|---|---|---|---|
| Colour intensity | 4.7 ± 0.7 ^{b} | 5.3 ± 0.7 ^{a} | 4.9 ± 0.7 ^{ab} |

Odour

| | | | |
|---|---|---|---|
| Overall odour intensity | 5.0 ± 0.7 | 4.9 ± 0.6 | 5.1 ± 0.6 |
| Buttery odour | 5.0 ± 0.8 | 4.9 ± 0.6 | 4.9 ± 0.7 |
| Chocolate odour | 4.7 ± 0.6 | 4.4 ± 0.7 | 4.7 ± 0.8 |

Touch

| | | | |
|---|---|---|---|
| Oiliness | 5.3 ± 1.0 ^{b} | 6.1 ± 1.2 ^{a} | 5.3 ± 0.7 ^{b} |

Flavour

| | | | |
|---|---|---|---|
| Overall flavour intensity | 5.4 ± 0.7 | 5.0 ± 0.7 | 5.2 ± 0.6 |
| Creamy/fatty flavour | 5.1 ± 0.4 | 5.0 ± 0.8 | 5.1 ± 0.3 |
| Sweetness | 5.3 ± 0.5 | 5.3 ± 0.5 | 5.2 ± 0.6 |
| Chocolate flavour | 5.0 ± 0.7 | 4.7 ± 0.6 | 4.9 ± 0.9 |
| Saltiness | 4.9 ± 0.4 | 4.5 ± 0.6 | 4.7 ± 0.8 |
| Acidity | 4.8 ± 0.8 | 4.6 ± 0.7 | 4.6 ± 0.6 |

Texture

| | | | |
|---|---|---|---|
| Hardness | 4.7 ± 0.5 ^{b} | 5.6 ± 0.6 ^{a} | 4.9 ± 0.9 ^{b} |
| Crunchiness | 5.1 ± 0.6 ^{b} | 5.6 ± 0.8 ^{a} | 5.1 ± 0.8 ^{b} |
| Crumbliness | 5.1 ± 0.6 | 5.0 ± 0.9 | 5.0 ± 0.8 |
| Moistness | 5.4 ± 0.6 | 5.4 ± 0.5 | 5.4 ± 0.6 |
| Fat mouthfeel | 5.1 ± 0.7 ^{b} | 5.6 ± 0.6 ^{a} | 5.2 ± 0.7 ^{ab} |

Overall

| | | | |
|---|---|---|---|
| Overall sensory quality | 5.2 ± 0.5 | 4.8 ± 0.6 | 5.2 ± 0.6 |

2. Consumer analysis (hedonic)

| | | | |
|---|---|---|---|
| Overall | 5.1 ± 0.7 ^{a} | 4.3 ± 0.9 ^{b} | 5.0 ± 0.7 ^{a} |
| acceptability (n = 36) | | | |

### (d) Instrumental Analysis of the Cookie Products

TABLE 20
Instrumental analysis profile of cookies
prepared with the PALM-ALT composiiton

| | | | |
|---|---|---|---|
| | Palm-based | | |
| Properties | shortening | Rapeseed oil | PALM-ALT |

Physicochemical properties

| | | | |
|---|---|---|---|
| Water activity | 0.22 ± 0.07 | 0.21 ± 0.01 | 0.25 ± 0.01 |
| Moisture (%) | 2.93 ± 0.58 | 2.83 ± 0.01 | 3.50 ± 0.05 |

Texturometry

| | | | |
|---|---|---|---|
| Hardness (N) | 50.18 ± 19.74 ^{b} | 62.17 ± 24.24 ^{a} | 46.52 ± 20.72 ^{b} |

Similarly to the sensory results, the instrumental analysis highlighted that the hardness of the PALM-ALT product was similar to that of the palm-based shortening control, while the rapeseed oil control was significantly harder than the palm-based shortening and PALM-ALT products (p<0.05) (Table 20). The other parameters were similar between the three products.

### (e) Conclusion

The results highlighted that the PALM-ALT model cookies closely matched the sensory and instrumental texture profiles of the palm-based shortening cookie control (whereas the rapeseed oil control did not) while offering nutritional benefits (reduced saturated fat claim).

Characterisation of Palm-Free Model Bread Prepared with the PALM-ALT Formulation

### (a) Composition of the Bread Products

Table 21 shows the composition of bread prepared with the PALM-ALT formulation.

TABLE 21

| | Palm-based | | | | | |
|---|---|---|---|---|---|---|
| | shortening | | Rapeseed oil | | PALM-ALT | |
| Ingredient | Weight (g) | % | Weight (g) | % | Weight (g) | % |
| Strong white bread flour | 1,000 | 59.2 | 1,000 | 59.2 | 1,000 | 59.2 |
| Water | 600 | 35.5 | 600 | 35.5 | 600 | 35.5 |
| Fast acting yeast | 14 | 0.8 | 14 | 0.8 | 14 | 0.8 |
| Salt | 14 | 0.8 | 14 | 0.8 | 14 | 0.8 |
| Wheat | 12 | 0.7 | 12 | 0.7 | 12 | 0.7 |
| Palm fat shortening | 30 | 1.8 | 0 | 0.0 | 0 | 0.0 |
| Rapeseed oil | 0 | 0.0 | 30 | 1.8 | 0 | 0.0 |
| PALM-ALT | 0 | 0.0 | 0 | 0.0 | 30 | 1.8 |
| Bread improver | 22 | 1.2 | 22 | 1.2 | 22 | 1.2 |
| Total | 1,690 | 100.0 | 1,690 | 100.0 | 1,690 | 100.0 |

The PALM-ALT component was incorporated in its formulation at the same concentration than palm-based shortening and rapeseed oil in their respective formulations.

### (b) Nutritional Profile of the Bread Products

Table 22 shows the nutritional profile of bread prepared with the PALM-ALT formulation

TABLE 22

| Nutrient | Palm-based | Rapeseed | PALM- | % difference | % difference |
|---|---|---|---|---|---|
| (per 100 g) | shortening | oil | ALT | in PA (PBS | in PA (RO |
| (pre-bake stage) | (PBS) | (RO) | (PA) | comparison) | comparison) |
| Energy (kJ) | 935 | 935 | 918 | −1.8% | −1.8% |
| Energy (kcalories) | 223 | 223 | 219 | −1.8% | −1.8% |
| Fat (g) | 2.6 | 2.6 | 2.1 | −17.2% | −17.2% |
| Saturated fat (g) | 0.9 | 0.3 | 0.3 | −70.4% | −9.4% |
| Monounsaturated | 1.5 | 1.7 | 1.4 | −1.9% | −15.1% |
| fat (g) | | | | | |
| Polyunsaturated | 0.2 | 0.6 | 0.4 | +75.8% | −25.3% |
| fat (g) | | | | | |
| Carbohydrate (g) | 40.6 | 40.6 | 40.6 | | |
| Sugar (g) | 0.9 | 0.9 | 0.9 | | |
| Fibre (g) | 1.9 | 1.9 | 2.0 | | |
| Protein (g) | 8.8 | 8.8 | 8.9 | | |
| Sodium as salt (g) | 0.8 | 0.8 | 0.8 | | |

Thus, as shown in Table 22, the “PALM-ALT” formulation provides dramatically reduced saturated fat content in comparison with palm-based shortening product. The PALM-ALT bread formulation also shows a lower total fat level (17.2% decrease) and a higher polyunsaturated fat level (75.8% increase) than the palm-based shortening formulation.

### (c) Sensory Analysis of the Bread Products

TABLE 23
Sensory analysis profile of bread prepared
with the PALM-ALT composition

| | | | |
|---|---|---|---|
| | Palm-based | Rapeseed | PALM- |
| Properties | shortening | oil | ALT |

1. Quantitative Descriptive Analysis (QDA)
Appearance/colour

| | | | |
|---|---|---|---|
| Crust colour | 5.1 ± 0.4 ^{ab} | 5.6 ± 0.7 ^{a} | 4.7 ± 1.1 ^{b} |
| Crumb density | 3.8 ± 0.8 ^{b} | 4.8 ± 1.1 ^{a} | 4.2 ± 1.3 ^{b} |

Odour

| | | | |
|---|---|---|---|
| Overall odour intensity | 5.3 ± 0.8 | 4.9 ± 0.8 | 5.0 ± 1.0 |

Flavour

| | | | |
|---|---|---|---|
| Overall flavour intensity | 4.8 ± 0.8 | 4.8 ± 0.8 | 4.6 ± 0.9 |
| Savouriness | 4.9 ± 1.0 | 4.8 ± 0.8 | 4.7 ± 1.0 |
| Saltiness | 4.4 ± 0.8 | 4.6 ± 0.8 | 4.3 ± 0.8 |
| Sweetness | 4.4 ± 0.8 | 4.6 ± 0.7 | 4.5 ± 0.8 |

Crumb Texture

| | | | |
|---|---|---|---|
| Chewiness | 4.7 ± 1.1 | 4.7 ± 1.1 | 5.0 ± 1.2 |
| Moistness | 5.3 ± 0.7 | 5.5 ± 0.8 | 5.5 ± 0.7 |

Crust Texture

| | | | |
|---|---|---|---|
| Firmness | 5.8 ± 0.7 | 5.9 ± 0.8 | 5.5 ± 1.1 |
| Chewiness | 5.2 ± 0.5 | 5.3 ± 0.8 | 5.1 ± 1.1 |
| Moistness | 4.7 ± 0.7 ^{b} | 5.1 ± 0.8 ^{a} | 4.8 ± 0.8 ^{ab} |

Overall

| | | | |
|---|---|---|---|
| Overall sensory quality | 5.2 ± 0.9 | 5.2 ± 0.6 | 4.8 ± 1.0 |

2. Consumer analysis (hedonic)

| | | | |
|---|---|---|---|
| Overall | 5.0 ± 1.2 | 5.1 ± 1.1 | 4.7 ± 1.3 |
| acceptability (n = 36) | | | |

The sensory analysis highlighted that the crumb density and moistness of the PALM-ALT product were similar to those of the palm-based shortening control, while the values obtained with the rapeseed oil control for these attributes were significantly different to the palm-based shortening product (p<0.05) (Table 23). The other parameters were similar between the three products.

### (d) Instrumental Analysis of the Bread Products

TABLE 24
Instrumental analysis profile of bread
prepared with the PALM-ALT composition

| | | | |
|---|---|---|---|
| | Palm-based | Rapeseed | PALM- |
| Properties | shortening | oil | ALT |

Physicochemical properties

| | | | |
|---|---|---|---|
| Water | 0.97 ± 0.01 | 0.96 ± 0.01 | 0.96 ± 0.01 |
| activity | | | |
| Moisture (%) | 42.19 ± 0.27 | 42.22 ± 0.33 | 42.60 ± 0.01 |

CIE-Lab colour

| | | | |
|---|---|---|---|
| Light- | 48.41 ± 1.15 | 49.24 ± 2.82 | 50.57 ± 2.97 |
| ness (L*) | | | |
| Redness (a*) | 8.07 ± 1.08 | 8.63 ± 1.21 | 8.68 ± 2.97 |
| Yellow- | 11.42 ± 1.41 | 11.87 ± 1.45 | 11.75 ± 1.46 |
| ness (b*) | | | |
| Hue (h*) | 14.01 ± 1.77 | 14.72 ± 1.88 | 14.65 ± 1.95 |
| Chroma (C*) | 55.58 ± 0.66 | 55.26 ± 0.73 | 54.98 ± 0.91 |

Texture Profile Analysis (TPA) of the crumb

| | | | |
|---|---|---|---|
| Hardness (g) | 24.61 ± 8.49 ^{b} | 33.41 ± 12.15 ^{a} | 22.25 ± 9.27 ^{b} |
| Springiness | 0.92 ± 0.02 | 0.93 ± 0.01 | 0.92 ± 0.02 |
| Cohe- | 0.61 ± 0.04 | 0.58 ± 0.04 | 0.62 ± 0.04 |
| siveness | | | |
| Gumminess | 15.18 ± 5.30 ^{b} | 19.94 ± 6.60 ^{a} | 13.90 ± 5.44 ^{b} |
| Chewiness | 13.85 ± 5.82 ^{b} | 18.38 ± 7.38 ^{a} | 12.81 ± 6.09 ^{b} |

The instrumental analyses highlighted that the hardness, gumminess and chewiness of the PALM-ALT product were similar to those of the palm-based shortening control, while the values obtained with the rapeseed oil control for these attributes were significantly higher than the palm-based shortening and PALM-ALT products (p<0.05) (Table 24). The other parameters were similar between the three products.

### (e) Conclusion

The results highlighted that the PALM-ALT model bread closely matched the sensory and instrumental texture profiles of the palm-based shortening bread control (whereas the rapeseed oil control did not) while offering nutritional benefits (reduced saturated fat claim).

Characterisation of Vegan Mayonnaise Prepared with the PALM-ALT Formulation

### (a) Composition of the Mayonnaise Products

The PALM-ALT component (composed of defatted linseed meal and beta-glucan extract) was incorporated in the full-fat vegan mayonnaise at the same solid content (3.2%) than the egg components of the full-fat vegan mayonnaise (Table 25). The two full-fat products were formulated at comparable water content (22.0 and 22.9%) and oil content (70.4%).

The PALM-ALT component was incorporated in the reduced-fat vegan mayonnaise at a slightly higher solid content (3.9%) than the egg components of the full-fat vegan mayonnaise (3.2%), as the egg-based formulation displayed a more suitable sensory profile at 3.2% egg solids than at 3.9%. The two reduced-fat products were formulated at similar oil content (60.2%). The water content of the reduced-fat vegan mayonnaise (27.9%) was slightly higher than that of the egg-based formulation (26.9%).

The amounts of starch (Avante 10) incorportated in the vegan mayonnaises were lower than those of their egg-based counterparts.

### (b) Nutritional Profile of the Mayonnaise Products

Table 26 shows the nutritional profile of vegan mayonnaise products prepared with the PALM-ALT formulation.

TABLE 25
Composition of vegan mayonnaises prepared with the PALM-ALT ingredient

| | FF-EM Full-Fat | | FF-VM Full-Fat | | RF-EM Reduced-Fat | | RF-VM Reduced-Fat | |
|---|---|---|---|---|---|---|---|---|
| | Egg Mayonnaise | | Vegan Mayonnaise | | Egg Mayonnaise | | Vegan Mayonnaise | |
| Ingredient | Weight (g) | % | Weight (g) | % | Weight (g) | % | Weight (g) | % |
| Dry mix | | | | | | | | |
| Defatted linseed meal (PALM-ALT) | 0 | 0.0 | 7 | 2.5 | 0 | 0.0 | 9 | 3.2 |
| Beta-glucan extract (PALM-ALT) | 0 | 0.0 | 2 | 0.7 | 0 | 0.0 | 2 | 0.7 |
| Salt | 3 | 1.0 | 3 | 1.0 | 3 | 1.0 | 3 | 1.0 |
| Sugar | 3 | 1.0 | 3 | 1.0 | 3 | 1.0 | 3 | 1.0 |
| Avante 10 starch (Ulrick & Short) | 9 | 3.1 | 3 | 1.1 | 26 | 9.2 | 15 | 5.3 |
| Liquid phase | | | | | | | | |
| Water | 44 | 15.5 | 55 | 19.3 | 50 | 17.6 | 64 | 22.6 |
| Vinegar | 3 | 1.1 | 3 | 1.1 | 5 | 1.6 | 5 | 1.6 |
| Lemon Juice | 7 | 2.5 | 7 | 2.5 | 11 | 3.7 | 11 | 3.7 |
| Dijon Mustard | 1 | 0.4 | 1 | 0.4 | 2 | 0.7 | 2 | 0.7 |
| Egg yolk | 7 | 2.5 | 0 | 0.0 | 7 | 2.5 | 0 | 0.0 |
| Whole egg | 7 | 2.5 | 0 | 0.0 | 7 | 2.5 | 0 | 0.0 |
| Oil phase | | | | | | | | |
| Rapeseed oil | 200 | 70.4 | 200 | 70.4 | 171 | 60.2 | 171 | 60.2 |
| Total weight | 284 | 100.0 | 284 | 100.0 | 284 | 100.0 | 284 | 100.0 |
| Total water content | 63 | 22.0 | 65 | 22.9 | 74 | 26.0 | 79 | 27.9 |
| Total egg solid content | 9 | 3.2 | 0 | 0.0 | 9 | 3.2 | 0 | 0.0 |
| Total PALM-ALT solid content | 0 | 0.0 | 9 | 3.2 | 0 | 0.0 | 11 | 3.9 |

TABLE 26

| | | | RF-EM | RF-VM | % difference | % difference | % difference |
|---|---|---|---|---|---|---|---|
| Nutrient | FF-EM Full- | FF-VM Full- | Reduced- | Reduced- | in FF-VM | in RF-VM | in RF-VM |
| (per 100 g) | Fat Egg | Fat Vegan | Fat Egg | Fat Vegan | (FF-EM | (RF-EM | (FF-EM |
| (pre-bake stage) | Mayonnaise | Mayonnaise | Mayonnaise | Mayonnaise | comparison) | comparison) | comparison) |
| Energy (kJ) | 2,770 | 2,724 | 2,485 | 2,418 | −1.7% | −2.7% | −14.1% |
| Energy (kcalories) | 662 | 651 | 594 | 578 | −1.7% | −2.7% | −14.1% |
| Fat (g) | 71.4 | 70.7 | 61.2 | 60.6 | −1.0% | −1.1% | −17.7% |
| Saturated fat (g) | 4.9 | 4.7 | 4.3 | 4.0 | −4.9% | −5.4% | −20.9% |
| Monounsaturated | 40.5 | 40.1 | 34.7 | 34.3 | −0.9% | −1.1% | −17.8% |
| fat (g) | | | | | | | |
| Polyunsaturated | 22.7 | 22.5 | 19.4 | 19.3 | −0.6% | −0.3% | −17.6% |
| fat (g) | | | | | | | |
| Carbohydrate (g) | 4.1 | 2.5 | 10.0 | 6.6 | | | |
| Sugar (g) | 1.1 | 1.2 | 1.2 | 1.3 | | | |
| Fibre (g) | 0.1 | 1.1 | 0.1 | 1.3 | | | |
| Protein (g) | 0.8 | 0.9 | 0.9 | 1.2 | | | |
| Sodium as salt (g) | 1.1 | 1.1 | 1.1 | 1.1 | | | |

As shown in Table 26, the full-fat egg and vegan mayonnaise products showed comparable nutritional profiles, as did the reduced-fat egg and vegan mayonnaise products (Table 26). The reduce-fat vegan mayonnaise showed lower total fat (17.7% decrease) and lower saturated fat (20.9% decrease) contents than the full-fat egg mayonnaise

### (c) Sensory Analysis of the Mayonnaise Products

The four samples displayed a number of statistically different sensory attributes (p<0.05) (Table 27). The overall flavour intensity, overall sensory quality and the overall acceptability of the reduced-fat vegan mayonnaise was similar to those of the two full-fat samples (p>0.05), whereas the reduced-fat egg mayonnaise showed significantly lower values for these three attributes in comparison with the full-fat samples (p<0.05). In addition the reduced-fat vegan mayonnaise was the only sample with a similar overall flavour intensity to the full-fat egg mayonnaise control (p>0.05).

### (d) Instrumental Analysis of the Mayonnaise Products

Instrumental analysis of the mayonnaise product is shown in Table 28. The four samples displayed a number of statistically different instrumental colour and texture attributes (p<0.05) (Table 25).

### (e) Conclusion

The results highlighted that the sensory profile of the novel reduced-fat vegan mayonnaise was closer to the full-fat egg mayonnaise than the reduced-fat egg mayonnaise (in terms of overall flavour intensity, overall sensory quality and the overall acceptability) while offering nutritional benefits (lower total fat and lower saturated fat levels). The novel vegan mayonnaises also offer a reduction in the number of allergenic components in comparison with competitors including those prepared with soy-and egg-based ingredients.

TABLE 27
Sensory analysis profile of vegan mayonnaise products
prepared with the PALM-ALT composition

| | | | | |
|---|---|---|---|---|
| | FF-EM | FF-VM | RF-EM | RF-VM |
| | Full-Fat | Full-Fat | Reduced-Fat | Reduced-Fat |
| | Egg May- | Vegan May- | Egg May- | Vegan May- |
| Properties | onnaise | onnaise | onnaise | onnaise |

Quantitative Descriptive Analysis (QDA)
Appearance/colour

| | | | | |
|---|---|---|---|---|
| Colour intensity | 4.7 ± 0.7 ^{b} | 4.9 ± 1.9 ^{b} | 5.5 ± 1.0 ^{ab} | 5.8 ± 2.8 ^{a} |
| Thickness | 4.4 ± 0.7 ^{c} | 4.5 ± 1.0 ^{c} | 6.7 ± 1.2 ^{a} | 5.7 ± 1.2 ^{b} |
| Oiliness | 5.2 ± 0.5 | 5.3 ± 0.9 | 5.4 ± 0.6 | 5.3 ± 0.8 |
| Glossiness | 5.5 ± 0.9 ^{a} | 5.8 ± 0.9 ^{a} | 5.0 ± 0.8 ^{b} | 4.7 ± 0.8 ^{b} |

Odour

| | | | | |
|---|---|---|---|---|
| Overall odour | 4.6 ± 0.6 ^{b} | 4.9 ± 0.7 ^{a} | 3.8 ± 0.6 ^{c} | 4.2 ± 0.7 ^{bc} |
| intensity | | | | |
| Acidic aroma | 4.8 ± 1.0 ^{a} | 5.3 ± 0.8 ^{a} | 3.7 ± 0.9 ^{c} | 4.2 ± 0.6 ^{b} |
| Fatty aroma | 4.4 ± 0.8 ^{b} | 4.9 ± 0.9 ^{a} | 3.7 ± 0.6 ^{c} | 4.3 ± 0.7 ^{b} |

Flavour

| | | | | |
|---|---|---|---|---|
| Overall flavour | 5.7 ± 0.8 ^{a} | 5.8 ± 1.1 ^{a} | 4.8 ± 1.0 ^{b} | 5.4 ± 0.8 ^{ab} |
| intensity | | | | |
| Acidity | 5.9 ± 0.7 ^{a} | 6.3 ± 1.5 ^{a} | 4.4 ± 0.8 ^{c} | 5.2 ± 0.8 ^{b} |
| Oily taste | 5.4 ± 0.5 | 5.0 ± 1.0 | 4.9 ± 0.7 | 5.1 ± 0.7 |
| Saltiness | 5.3 ± 0.3 ^{a} | 5.3+ 0.6 ^{a} | 5.0 ± 0.3 ^{b} | 5.1 ± 0.2 ^{ab} |

Texture

| | | | | |
|---|---|---|---|---|
| Thickness | 4.2 ± 0.7 ^{c} | 3.9 ± 1.2 ^{c} | 6.1 ± 0.8 ^{a} | 5.2 ± 1.0 ^{b} |
| Fat mouthfeel | 5.1 ± 0.8 | 4.9 ± 0.6 | 5.6 ± 0.7 | 5.2 ± 0.5 |

Overall

| | | | | |
|---|---|---|---|---|
| Overall sensory | 4.7 ± 0.6 ^{a} | 4.7 ± 0.7 ^{a} | 3.9 ± 0.5 ^{b} | 4.3 ± 0.7 ^{ab} |
| quality | | | | |

2. Consumer analysis (hedonic)

| | | | | |
|---|---|---|---|---|
| Overall | 4.4 ± 1.2 ^{a} | 4.3 ± 1.2 ^{a} | 3.1 ± 1.7 ^{b} | 3.5 ± 1.1 ^{ab} |
| acceptability | | | | |

TABLE 28
Instrumental analysis profile of vegan mayonnaise
products prepared with the PALM-ALT formulation

| | FF-EM | FF-VM | RF-EM | RF-VM |
|---|---|---|---|---|
| | Full-Fat Egg | Full-Fat Vegan | Reduced-Fat Egg | Reduced-Fat Vegan |
| Properties | Mayonnaise | Mayonnaise | Mayonnaise | Mayonnaise |
| pH | 4.37 ± 0.01 | 3.97 ± 0.01 | 4.32 ± 0.01 | 3.83 ± 0.01 |

Texturometry

| | | | | |
|---|---|---|---|---|
| Firmness (N) | 0.56 ± 0.06 ^{b} | 1.47 ± 0.08 ^{a} | 0.57 ± 0.01 ^{b} | 1.47 ± 0.07 ^{a} |

CIE-Lab colour

| | | | | |
|---|---|---|---|---|
| Lightness (L*) | 90.51 ± 0.41 ^{a} | 81.58 ± 0.24 ^{b} | 89.97 ± 0.75 ^{a} | 83.09 ± 0.48 ^{b} |
| Redness (a*) | 2.62 ± 0.13 ^{c} | 4.89 ± 0.18 ^{b} | 4.29 ± 0.36 ^{b} | 5.89 ± 0.49 ^{a} |
| Yellowness (b*) | 9.86 ± 0.14 ^{c} | 12.30 ± 0.15 ^{b} | 12.23 ± 0.44 ^{b} | 13.81 ± 0.27 ^{a} |
| Hue (h*) | 10.21 ± 0.16 ^{c} | 13.23 ± 0.20 ^{b} | 12.96 ± 0.53 ^{b} | 15.01 ± 0.44 ^{a} |
| Chroma (C*) | 75.17 ± 0.65 ^{a} | 68.36 ± 0.54 ^{bc} | 70.72 ± 0.88 ^{b} | 66.96 ± 1.28 ^{c} |

It will be appreciated that the described embodiments are not meant to limit the scope of the present invention, and the present invention may be implemented using variations of the described examples.

1. A palm-based shortening substitute composition comprising:
(i) linseed meal;
(ii) a beta-glucan source;
(iii) an oil;
(iv) an acidifier; and
(v) water.

2. A composition according to claim 1, wherein the amount of linseed meal in the composition is in the range of about 0.1 to about 6 wt % based on the total weight of the composition.

3. A composition according to claim 2, wherein the amount of linseed meal in the composition is in the range of about 2 to about 3 wt % based on the total weight of the composition.

4. A composition according to claim 1, wherein the amount of beta glucan source in the composition is in the range of about 0.1 to about 2 wt % based on the total weight of the composition.

5. A composition according to claim 4, wherein the amount of beta glucan source in the composition is in the range of about 0.2 to about 0.5 wt % based on the total weight of the composition.

6. A composition according to claim 1, wherein the beta-glucan source has a beta-glucan content of about 20-40 wt %.

7. A composition according to claim 1, wherein the amount of beta glucan in the composition is in the range of about 0.03 to about 0.58 wt % based on the total weight of the composition

8. A composition according to claim 7, wherein the amount of beta glucan in the composition is in the range of about 0.06 to about 0.15 wt %, based on the total weight of the composition.

9. A composition according to claim 1, wherein the oil is selected from rapeseed oil and/or sunflower oil.

10. A composition according to claim 1, wherein the amount of oil in the composition is in the range of about 50 to about 90 wt %, based on the total weight of the composition.

11. A composition according to claim 1, wherein the acidifier comprises one or more acidifiers selected from the group consisting of cider vinegar, white wine vinegar, red wine vinegar, lemon juice, citric acid, malic acid or combinations thereof.

12. A composition according to claim 1, wherein the amount of acidifier in the composition is in the range of about 0.1 to about 7 wt %, based on the total weight of the composition.

13. A composition according to claim 1, wherein the amount of water in the composition is in the range of about 10 to about 50 wt %, based on the total weight of the composition.

14. A composition according to claim 1, wherein composition is an oil-in-water emulsion.

15. A composition comprising or consisting of:
(i) about 2 to about 3 wt % linseed meal;
(ii) about 0.2 to about 0.5 wt % of a 29 wt % beta-glucan source;
(iii) about 70 to about 80 wt % of rapeseed oil;
(iv) about 1 to about 2 wt % of an organic acidifier such as a 5% acidity aqueous acid solution; and
(v) about 15 to about 25 wt % water,
wherein the total amounts of components (i)-(v) add to 100%.

16. A composition comprising or consisting of:
(i) about 2 to about 3 wt % linseed meal;
(ii) about 0.06 to about 0.15 wt % of beta-glucan;
(iii) about 70 to about 80 wt % of rapeseed oil;
(iv) about 1 to about 2 wt % of an organic acidifier such as a 5% acidity aqueous acid solution; and
(v) about 15 to about 25 wt % water,
wherein the total amounts of components (i)-(v) add to 100%.

17. A method for preparing a composition, the method comprising:
(a) combining linseed meal and a beta-glucan source;
(b) adding an oil; and
(c) adding water and an acidifier.

18. (canceled)

19. An edible item, wherein the edible item comprises a composition comprising:
(i) linseed meal;
(ii) a beta-glucan source;
(iii) an oil;
(iv) an acidifier; and
(v) water.

20. An edible item according to claim 19, wherein the edible item is selected form the group consisting of oatcake, biscuit, cookie, bread, cake, or mayonnaise.
